(19) United States
(12) Patent Application Publication
(10) Pub. No.: US 2010/0269851 A1
(43) Pub. Date: Oct. 28, 2010

(54) NUCLEAR DECONTAMINATION DEVICE AND A METHOD OF DECONTAMINATING RADIOACTIVE MATERIALS

(76) Inventor: Eisuke Minehara, Tsuruga-shi (JP)

Correspondence Address: SMITH PATENT OFFICE, 1901 PENNSYLVANIA AVENUE N W, SUITE 901, WASHINGTON, DC, 20006, US

(21) Appl. No.: 12/768,826

(22) Filed: Apr. 28, 2010

(30) Foreign Application Priority Data
Apr. 28, 2009 (JP) JP 2009-109062

(51) Int. Cl. G21F 9/00; B08B 7/00

(52) U.S. Cl. 134/1

(57) ABSTRACT

This is an efficient nuclear decontamination device using the laser light to remove the radioactive substance from the polluted parts of the radioactive object sample in the nuclear devices and facilities. In the nuclear decontamination device, the laser source (11) of the oscillator and amplifier system is used to irradiate on the surface (20) of the decontamination object sample through the condensing optics (12). The controller (13) optimizes the laser energy density on the surface by using both of the laser sources (11) and condensing optics (12). In the optimization, the energy density per pulse is controlled by optics system (12) of condensing within the range of 1 J/cm²-1000 J/cm² in the surface of the decontamination object sample (20). Minimum beam spot size and Rayleigh length are chosen to keep the energy density per pulse in the above-mentioned range of the energy density.

### BACKGROUND OF THE INVENTION

1. Field of the Invention

This invention relates to a nuclear decontamination device and a method of removing radioactive substances on the surface of an object to be decontaminated, the surface of the object being polluted with the radioactive substances.

2. Description of the Related Art

At dismantlement, abandonment, and the regular maintenance of the nuclear devices and facilities like nuclear reactors and accelerators (hereinafter, the accelerators and similar ones) that generate a strong radiation, it is mandatory to abandon the material polluted with the radioactive substance. Whenever the polluted parts of the nuclear devices and facilities are dismantled and abandoned, it is mandatory to abandon it after the radioactive substance such as ⁶⁰Co (contaminant) and other radioisotopes have to be removed from the parts. A number of methods of the nuclear decontamination have been well known to remove the radioactive substance from the polluted parts of the nuclear devices and facilities. For instance, the radioactive substance can be removed by chemically acid-etching and by physically grinding down of the sand-blasting the surface of the polluted sample, and so on. However, because a large amount of wastes (secondary waste) containing the removed radioactive substance from the sample are produced in the conventional nuclear decontamination methods, a detachment of the radioactive substance from the secondary wastes that is complicate, time-consuming and very expensive processing is needed to complete the nuclear decontamination.

On the other hand, the nuclear decontamination method using laser light is extremely advantageous because the laser decontamination technology to evaporate instantly or to sublime the radioactive substance by irradiating the surface of the decontamination object sample (polluted object sample) produces comparatively little or no secondary waste.

For instance, the technology that evaporates the contaminant by irradiating the surface of the polluted object sample because of pulsed laser light with extremely short duration of hundreds of (fs) femtoseconds or less has been described in patent document 1. In Patent document 1, the radioactive substance of the polluted object sample is instantly evaporated or sublimed by irradiating pulsed laser light (non-thermally evaporation by laser light) with such a extremely short duration, and the radioactive substance of the polluted object sample is removed without heating neighboring region around the evaporated and sublimed spot area. The removed radioactive substance from the polluted object sample is washed away with the gaseous or liquid fluid or the mixture fluid that flows on the surface of the decontamination object sample and is collected in the mesh filter.

Moreover, because the fluid flushing cools the decontamination object sample, and the temperature of the object sample is not raised, diffusion and the re-adhesion of the radioactive substance in the object sample can be inhibited.

In Patent document 2, the water jet guided laser technology is described to decontaminate the radioactive object sample.

The water jet of the laser efficiently keeps the decontamination object sample cool, and resultantly inhibits the temperature rise of the sample and the diffusion of the radioactive substance in the sample.

Moreover, the result of the decontamination processing on the carbon steel by using the pulsed laser light with the pulse energy density of 7.5×10⁷ W/cm² and pulse length of 75 ns that was longer than the laser light described in patent document 1 was shown in non-patent document 1. According to the non-patent document 1, the above-mentioned laser system in the same irradiation condition was successfully reported to decontaminate the radioactive substance from the polluted carbon steel.

[Patent document 1] Japanese Kokai 2007-315995

[Patent document 2] Japanese Kokai 2007-315996

[Non-patent document 1] Koichi Hayashi, Koichi Kitamura, Yasuyuki Nakamura, et. al. Atomic Energy Society of Japan, Autumn Meeting 2007, J08.

### SUMMARY OF THE INVENTION

However, whenever the decontamination processing on stainless steel using the same laser was done on the same condition of the carbon steel, the decontamination efficiency was reported to be extremely low, almost no effect, and insufficient in the above-mentioned non-patent documents 1.

That is, it was difficult to decontaminate efficiently in an actual radioactive object sample that was polluted inside the primary cooling system being made from stainless steel in the nuclear power plant by using the laser light.

The nuclear decontamination device and method are invented to consider and to solve the problem. And, it aimed to offer the invention that solves the above-mentioned problem.

To solve the above-mentioned problem, the invention was constructed as follows. This invention relates to a nuclear decontamination device for removing radioactive materials by irradiating a laser light on an object to be decontaminated where the radioactive substances adhere directly to the surface of the object to be decontaminated which comprises:
a laser source for oscillating and amplifying a pulsed laser light;
a focusing optics system for condensing the laser light on the surface of the object to be contaminated,
a laser device controller for adjusting the laser light on the object to be decontaminated in a manner that the energy/unit pulse can be in a range of energy density from 1 J/cm² to 1000 J/cm².

In a preferred embodiment of the nuclear decontamination device, the laser device controller is used for adjusting a condensing spot area, a spot position and a Rayleigh length indicated by the formula: Zᵣ=π·W₀²/λ where λ is a wavelength of the laser light and W₀ is a minimum beam size of the laser light.

In another preferred embodiment, the nuclear decontamination device further comprises a means for flushing gaseous and liquid fluid on the surface of the object to be decontaminated.

This invention is also to provide a method of nuclear decontamination for removing radioactive substances by irradiating a laser light on a stainless steel object to be decontaminated where radioactive substances adhere directly to the surface of the stainless steel object which comprises:
a) oscillating a pulsed laser light from a laser source
b) condensing the pulsed laser light on the surface of the object to be decontaminated
c) adjusting the focusing optics system so as to condense the laser light energy/unit pulse on the surface of the object to be decontaminated in a range of the energy density from 1 J/cm² to 1000 J/cm², and
d) evaporating instantly or subliming the radioactive materials.

In a preferred method, there is further provided with a step of controlling a condensing spot area and spot position and a Rayleigh length of the laser light indicated of the formula: Zᵣ=π·W₀²/λ where λ is a wavelength of the laser light and W₀ is a minimum beam size by a degree of condensing in the optics system in a manner that the laser light energy on the surface of the object to be decontaminated is in a range of the energy density from 1 J/cm² to 1000 J/cm².

In another preferred method of the invention, there is further provided with a step of flushing gaseous and liquid fluid on the surface of object to be decontaminated.

Because the invention is consisted as above-mentioned already, the nuclear decontamination of the polluted object sample can be efficiently done by using the laser light.

### BRIEF DESCRIPTION OF THE DRAWINGS

The above and other objects, features and other advantages of a the present invention will more clearly understood from the following detailed description taken in conjunction with the accompanying drawings, in which:

FIG. 1 shows a construction of the decontamination device, the laser source, condensing optics, controller and others are shown.

FIG. 2 shows a relationship between the pulse energy density and the decontamination efficiency.

### DETAILED DESCRIPTION OF THE PREFERRED EMBODIMENT

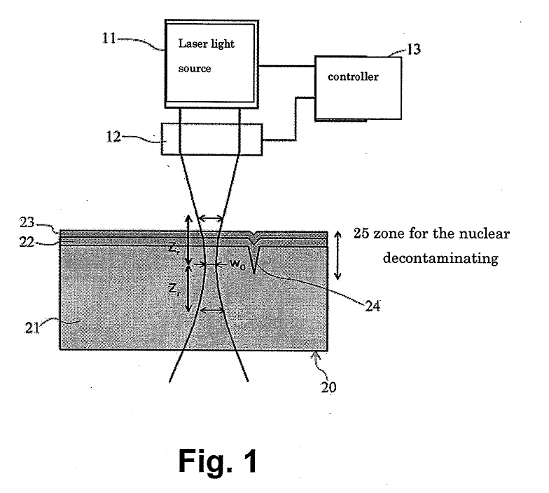

It explains the nuclear decontamination device and method that lies in the form of practicing this invention as follows. FIG. 1 shows the composition of the decontamination device that lies in the form and actual situation of practicing this invention.

The nuclear decontamination of the decontamination object sample (20) is done especially efficiently with the decontamination device. In the nuclear decontamination device, the laser light irradiates the surface (20) of the decontamination object sample by the laser light source (11). The laser light reaches the surface (20) of the decontamination object sample through the condensing optics system (12). The laser light source (11) and condensing optics system (12) are adjusted by controller part (13).

For instance, the laser light source (11) is a flash lamp excitation type Nd:YAG laser, and, oscillates at the wavelength of 1064 nm. The laser light oscillates in pulses, and the irradiation energy of the pulse and each pulse width are regulated by the controller part (13). In this case, the area density of energy per pulse is regulated by the condensing optics system (12) in the range from 1 J/cm2 to 1000 J/cm2 in the surface of the decontamination object sample (20).

The condensing optics system (12) is composed of two or more optical elements (lens and reflector, etc.), and condenses the laser light on the sample (20) being polluted. Here, condensing means the beam size become a minimum (The limited size of certain: minimum beam size) at one point on an optical axis. This condensing spot area and position, and Rayleigh length are adjusted by controller part (13). Here, Rayleigh length is a physical amount defined, for instance, as Zr by the 3283265th patent official report, and it corresponds to the focus depth of condensing. Concretely, it is Zᵣ=π·w₀²/λ where λ and w₀ are the minimum beam size and the wavelength, respectively. For instance, the control is usually done by moving vertically one of the optical elements of the condensing optics system (12) in FIG. 1. For examples, The beam size is concretely assumed to be 40 μm and Rayleigh length about 120 μm. The minimum beam size and the wavelength are adjusted to keep the area density of the energy per pulse to be within the above-mentioned by setting the spot size w₀ and Rayleigh length Zᵣ range when irradiated.

The controller part (13) is a personal computer, for instance, and, does the above-mentioned control according to the parameter that the user input. That is, the laser light source (11) and condensing optics system (12) are regulated by the controller part (13).

The cross-sectional structure of the decontamination object sample (20) that is the object to which the decontamination processing is done here is schematically a composition to which radioactive substance (22) typically adheres on the base metal (21) and iron oxide (rust) layer (23) as shown in the FIG. 1. In addition, the cracks and the pitting corrosion that originate from stress corrosion cracking and others due to the secular change and distortion are formed in the surface of the base metal (21), and the radioactive substance (22) has invaded into the base metal. Especially, the radioactive waste of the primary water cooling piping inside the nuclear power reactors is often observed to be the above-mentioned form. A vertical section in the direction where the crack (24) runs is shown in FIG. 1. For instance, the depth is usually smaller than the above-mentioned Rayleigh length though the depth of the crack and the pitting corrosion might become many hundreds of μm or longer for the waste at the decommissioning for old nuclear power plants. In addition, stainless steels (SUS304L, 316L and other relatives) are used for the primary water cooling piping of the nuclear power reactors as for the base metal (11).

The object that should be removed in the structural decontamination object sample (20) is from around the base metal (21) up to the depth of iron oxide layer (23) as viewed from above, the radioactive substance (22), and the crack (24) in the upper-middle side of the FIG. 1, and the ranges are shown by the arrow in FIG. 1 in the direction of depth.

The controller part (13) regulates the condensing optics system (12) in the decontamination device to adjust the condensing position within Rayleigh length range in the direction of depth, and to cover the surface of iron oxide layer (23) (an upper side in FIG. 1), and the radioactive substance (22) (an upper side in FIG. 1) and cracks (24). Concretely, the controller part (13) regulates so that the iron oxide layer (23), radioactive substance (22), and crack (24) are included within the range of 2Zᵣ indicated by arrows in the thickness direction in FIG. 1.

The decontamination rate was measured in the above-mentioned situation, as the energy density of the irradiation per the unit pulse of the laser light was changed where w₀=40 μm, and Zᵣ=120 μm, and the flash-lamp excitation type Nd:YAG laser (wavelength 1064 nm) was used here as laser light source (11). Here, iron oxide (rust) layers of a mock or simulated radioactive substance of about 2 μm (Because radioactive isotope was 60Co, stable isotope of 59Co was used here.) and iron oxide one of about 100 μm were accumulated on the base metal of SUS304L as a decontamination object sample (20), and the depth of the crack had become about 40 μm in the sample. It is shown by a relative value in the following results though the decontamination rate was assumed to be an inverse of the removal time to finish a decontamination process. The difference of the measured decontamination rate was measured to be ±about 20%.

As a result, in the pulse energy density of 1 J/cm² or more a significant decontamination rate has been obtained. That is, when the pulse energy density was less than this value, the decontamination in the above-mentioned decontamination object sample was not able to be processed effectively.

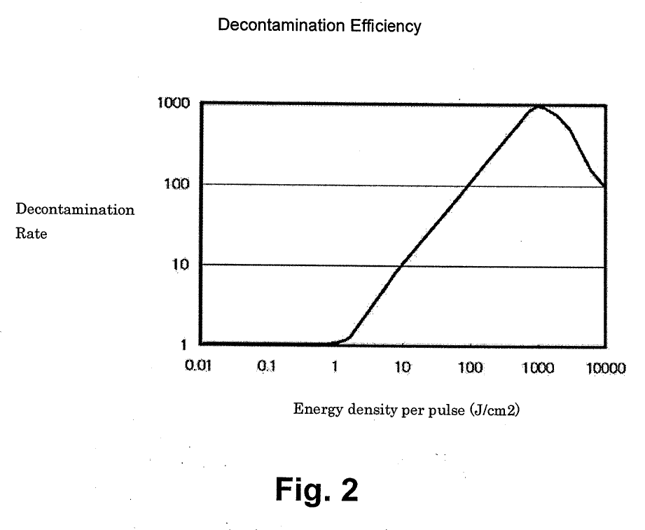

In addition, the decontamination rate vs. pulse energy density was examined as decontamination efficiency. The decontamination rate is a physical amount which shows how much pulse energy density is necessary to process the decontamination, and it shows here in the arbitrary unit being normalized with the decontamination rate when the pulse energy is 1 J/cm². FIG. 2 shows this result of the measurement. As a result, the decontamination rate decreases when the energy density exceeds 1000 J/cm², on the other hand the decontamination rate increases from 1 J/cm² to 1000 J/cm² according to an increase in the pulse energy density.

Table 1 shows a result of classifying the decontamination rate into three groups according to the pulse energy density. As a result, the range of the pulse energy density of 1-1000 J/cm² is the most desirable.

TABLE 1

| | | | |
|---|---|---|---|
| Pulse energy | Smaller than | 1 J/cm2-1000 J/cm2 | Larger than |
| density | 1 J/cm2 | | 1000 J/cm2 |
| Decontamination | X | ◯ | Δ |
| adaptability | | | |
| Detailed | impossible | possible/ | Saturated/ |
| adaptability/ | very small | large rate | decontamination |
| Decontamination | rate | | rate decreases |
| rate | | | not so efficient |

The results of the decontamination efficiency in table 1 were obtained by using the flash-lamp excitation type Nd:YAG laser (wavelength 1064 nm) as laser light source (11). An energy density dependency of the efficiency in other kinds of lasers and other wavelength has the similar tendency with the above-mentioned example in table 1. Table 2 shows the measured decontamination rates by using four different lasers as an alternative of the laser light source (11) having 4 different wavelengths from far-infrared to visible region, and 4 different pulse widths within the range from the pico-second to the nanosecond. Here, the decontamination rates for the four lasers were shown in the arbitrary unit being normalized with the decontamination rate for the laser wavelength of 0.53 μm. Within the wide wavelength range from 0.53 μm to 22 μm, the decontamination rates were measured to be most of the same.

Whenever the decontamination rate was higher than one, the wavelength dependency of the decontamination rate was observed to be most of the same.

TABLE 2

| | Laser | Decontamination |
|---|---|---|
| Laser type | wavelength | rate |
| FIR Laser | 22 | 0.62 |
| CO2 Laser | 10.6 | 0.7 |
| YAG (Fundamental) Laser | 1.064 | 0.91 |
| YAG (Doubled Frequency) Laser | 0.53 | 1 |

In addition, the decontamination rate was measured according to pulse width being changed from 100 fs (100×10⁻¹⁵ s) to 100 ns (100×10⁻⁹ s), when the pulse energy density was in the range from 10 J/cm2 to 100 J/cm2. Here, the Ti:Sapphire laser (wavelength 900 nm) was used as the laser source (11) when the pulse width was 100 fs, and 10 ps, and the flash-lamp excitation type Nd:YAG laser (wavelength 1064 nm) was used as the laser source (11) when the pulse width was 10 ns, and 100 ns. Table 3 shows the above-mentioned results. Here, the decontamination rates for the four pulse widths were shown in the arbitrary unit being normalized with the decontamination rate for the pulse width of 100 ns.

Within the wide pulse width ranging from 100 ns to 100 fs, the decontamination rates were measured to be very similar or almost the same. It can be confirmed that no clear pulse width dependence can be seen in the wide range of the four pulse widths.

Whenever the decontamination rate was higher than one, no clear pulse width dependency of the decontamination rate was observed.

TABLE 3

| Pulse width | Decontamination rate |
|---|---|
| 100 fs (femtosecond) | 0.72 |
| 10 ps (picosecond) | 0.8 |
| 10 ns (nanosecond) | 0.9 |
| 100 ns (nanosecond) | 1 |

Therefore, for instance, the high decontamination rate can be especially obtained on stainless steel by setting the pulse energy density within the range of 1 J/cm²-1000 J/cm² on the surface of decontamination object sample (20) even when the laser light source of a cheap and easily-available 100 mJ laser is used.

In this case, the high decontamination rate can be obtained with no dependence on the wavelength and pulse width of the laser light. Therefore, the available lasers can be used as a laser light source for the decontamination within the range where the above-mentioned specifications are obtained.

On the other hand, an expensive laser light source can oscillate in the extremely short pulse width of around fs (for instance, titanium sapphire laser), and is for instance necessary in the technology described in patent document 1. For instance the pulse width is 10 ns or more, and, for instance, Q switched YAG laser can be used as a cheap and easily-available laser light source for the decontamination device in the form of the invention.

Moreover, it did not obtain it on stainless steel though enough decontamination rate was obtained on the carbon steel by using the technology described in non-patent documents 1. Because the laser light reflects on the stainless-steel surface, this reason is thought that it is because the pulse energy density is substantially insufficient to remove instantly the polluted object sample on stainless steel.

On the other hand, especially high decontamination rate is obtained with the decontamination device that lies in the form of this execution in decontamination on stainless steel. The reason is as follows. The energy of the laser light is efficiently absorbed from the focus position to the decontamination object sample (base metal (21) up to the depth of the iron oxide layer (23), radioactive substance (22), and crack (24)) for the removal being included within Rayleigh length range, and first of all, can it evaporate instantly, and it be sublimed. This respect is contrasted with the technology described in the patent document 1 that uses non-thermal laser.

In addition, the fluid flushing can be introduced in the decontamination processes to prevent the evaporated and sublimed material from adhering to the surface of decontamination object sample (20) again on the surface of decontamination object sample (20) as well as the technology described in the patent document 1.

The gas such as inert gases and the liquid such as water can be used as the flushing fluid. However, it is not necessary to cool the decontamination object sample with the flushing fluid in the decontamination device that lies in the form of this execution.

In contrast, the role to cool in the vicinity of the irradiation area of the surface (20) of the decontamination object sample was done to flush the gaseous or liquid fluid, or the mixture fluid in the technology described in patent document 1.

Like the similar technology being described in the patent document 1, as the angle of the incidence laser light to the surface (20) in the decontamination object sample is decreased from the normal incident of 90°, the possibility that the material being evaporated and sublimed adheres to the decontamination object sample again can be decreased by the laser light recoiling of the flakes.

What is claimed is:

1. A nuclear decontamination device for removing radioactive materials by irradiating a laser light on an object to be decontaminated where the radioactive substances adhere directly to the surface of the object to be decontaminated which comprises:
a laser source for oscillating and amplifying a pulsed laser light;
a focusing optics system for condensing the laser light on the surface of the object to be contaminated,
a laser device controller for adjusting the laser light on the object to be decontaminated in a manner that the energy/unit pulse can be in a range of energy density from 1 J/cm² to 1000 J/cm².

2. The nuclear decontamination device according to claim 1 wherein the laser device controller is used for adjusting a condensing spot area, a spot position and a Rayleigh length indicated by the formula: Zᵣ=π·W₀²/λ where λ is a wavelength of the laser light and W₀ is a minimum beam size of the laser light.

3. The nuclear decontamination device according to claim 1 which further comprises a means for flushing gaseous and liquid fluid on the surface of the object to be decontaminated.

4. A method of nuclear decontamination for removing radioactive substances by irradiating a laser light on a stainless steel object to be decontaminated where radioactive substances adhere directly to the surface of the stainless steel object which comprises:
a) oscillating a pulsed laser light from a laser source
b) condensing the pulsed laser light on the surface of the object to be decontaminated
c) adjusting the focusing optics system so as to condense the laser light energy/unit pulse on the surface of the object to be decontaminated in a range of the energy density from 1 J/cm² to 1000 J/cm², and
d) evaporating instantly or subliming the radioactive materials.

5. The method of nuclear decontamination according to claim 4 which further comprises a step of controlling a condensing spot area and spot position and a Rayleigh length of the laser light indicated of the formula: Zᵣ=π·W₀²/λ where λ is a wavelength of the laser light and W₀ is a minimum beam size by a degree of condensing in the optics system in a manner that the laser light energy on the surface of the object to be decontaminated is in a range of the energy density from 1 J/cm² to 1000 J/cm².

6. The method of nuclear decontamination according to claim 4 which further comprises a step of flushing gaseous and liquid fluid on the surface of object to be decontaminated.
